(19) United States
(12) Patent Application Publication
(10) Pub. No.: US 2023/0076639 A1
(43) Pub. Date: Mar. 9, 2023

(54) METHOD FOR ENHANCING BIOLOGICAL DENITRIFICATION BASED ON ADDITION OF EXOGENOUS BETA CYCLODEXTRIN

(71) Applicant: Harbin Institute of Technology, Shenzhen, Shenzhen City (CN)

(72) Inventors: Xiaochi FENG, Shenzhen City (CN); Hongtao SHI, Shenzhen City (CN); Nanqi REN, Shenzhen City (CN); Zijie XIAO, Shenzhen City (CN); Zijian XU, Shenzhen City (CN)

(21) Appl. No.: 17/858,675

(22) Filed: Jul. 6, 2022

(30) Foreign Application Priority Data
Sep. 8, 2021 (CN) 202111049758.0

(51) Int. Cl. C02F 3/30

(52) U.S. Cl. CPC C02F 3/305; C02F 2101/163

(57) ABSTRACT

The present disclosure belongs to the technical field of water body treatment, and particularly relates to a method for enhancing biological denitrification based on the addition of exogenous β-cyclodextrin. Preferably, Paracoccus denitrificans and β-cyclodextrin are added for biological denitrification enhancement. In the present disclosure, the β-cyclodextrin is exogenously added to a denitrifying medium to construct a denitrification system, so that the denitrification rate of microorganisms may be increased and the production of harmful denitrification intermediate products is reduced.

### CROSS REFERENCE TO RELATED APPLICATION

This patent application claims the benefit and priority of Chinese Patent Application No. 202111049758.0, entitled METHOD FOR ENHANCING BIOLOGICAL DENITRIFICATION BASED ON ADDITION OF EXOGENOUS BETA-CYCLODEXTRIN filed on Sep. 8, 2021, the disclosure of which is incorporated by reference herein in its entirety for all purposes.

### TECHNICAL FIELD

The present disclosure belongs to the technical field of water body treatment, and particularly relates to a method for enhancing biological denitrification based on the addition of exogenous beta (β)-cyclodextrin.

### BACKGROUND ART

Excessive nitrogen content in the water body will cause the algae to multiply in the water, affect the environmental quality of the water body, break the ecological balance, and cause the eutrophication of the water body. The denitrification process is the core step of water nitrogen removal, which is mainly carried out by denitrifying microorganisms in the water body in an anaerobic environment.

Heterotrophic denitrification is a process in which microorganisms oxidize organic matter through respiration to obtain electrons under anaerobic conditions, and reduce nitrate nitrogen (NO₃⁻-N) to N₂ through electrons. Due to the slow rate of the anaerobic denitrification process, the denitrification process is limited by the concentration of organic substrates. At present, most treatment processes choose to feed organic substrates exogenously to enhance the denitrification effect.

Exogenous organic substrates will be continuously consumed by microorganisms during the denitrification process, so continuous feeding is required, and continuous feeding will be bound to greatly increase the disposal cost. Moreover, the denitrification process will produce the accumulation of nitrite and nitrous oxide. Herein, nitrite is toxic and will affect the safety of the water environment; nitrous oxide is a greenhouse gas, and the greenhouse effect caused by nitrous oxide is 300 times that caused by the same volume of carbon dioxide.

β-Cyclodextrin is a cup-shaped oligosaccharide with a hydrophobic inner cavity and a hydrophilic surface produced during the hydrolysis of amylose. In the present disclosure, exogenous feeding of β-cyclodextrin into a denitrifying medium to construct a denitrification system may promote the denitrification rate of microorganisms.

### SUMMARY

In view of the problems in the prior art, the present disclosure provides a method for improving anaerobic denitrification efficiency and reducing the production of harmful denitrification intermediate products through β-cyclodextrin.

Specifically, the present disclosure is realized through the following technical solution:

A method for enhancing biological denitrification based on the addition of exogenous β-cyclodextrin, including a step of adding a denitrifying microorganism and β-cyclodextrin to a water body containing nitrate to realize biological denitrification treatment.

In some embodiments of the present disclosure, the denitrifying microorganism may be selected from Paracoccus denitrificans.

In some embodiments of the present disclosure, the P. denitrificans may be added to the water body in a volume ratio of 1%. Inoculating a bacterial suspension with OD₆₀₀=1.0 in a volume ratio of 1% may control a consistent inoculum size in each treatment.

In some embodiments of the present disclosure, an amount of the β-cyclodextrin added in the water body may be 0.3-0.8 mM, and preferably 0.5 mM.

In some embodiments of the present disclosure, the denitrification treatment may be conducted at 20-40° C., and preferably 30° C.

In some embodiments of the present disclosure, the denitrification treatment may be conducted under stirring, and preferably at 200 rpm.

Compared to the prior art, the embodiments of present disclosure have the following beneficial effects:

(1) The β-cyclodextrin may accelerate the reduction ability of P. denitrificans to nitrite and reduce the accumulation of nitrite during denitrification.

(2) The β-cyclodextrin may make the denitrification process of the P. denitrificans more thorough and reduce the total amount of nitrous oxide produced in the denitrification process.

(3) The β-cyclodextrin improves electron transport system activity (ETSA) in the P. denitrificans.

(4) The β-cyclodextrin may achieve a more efficient and complete biological denitrification process by upregulating expression levels of denitrifying functional genes in the denitrifying model microorganism P. denitrificans.

### BRIEF DESCRIPTION OF THE DRAWINGS

FIG. 1 is a schematic diagram of the effects of different concentrations of β-cyclodextrin+P. denitrificans on nitrate removal;

FIG. 2 is a schematic diagram of the effects of β-cyclodextrin, P. denitrificans, and β-cyclodextrin+P. denitrificans on nitrate removal;

FIG. 3 is a schematic diagram of an effect of β-cyclodextrin on the accumulation of nitrous acid during denitrification;

FIG. 4 is a schematic diagram of an effect of β-cyclodextrin on the removal of total nitrogen during denitrification;

FIG. 5 is a schematic diagram of an effect of β-cyclodextrin on the release of nitrous oxide during denitrification;

FIG. 6 is a schematic diagram of an effect of β-cyclodextrin on ETSA of P. denitrificans; and

FIG. 7 is a schematic diagram of an effect of β-cyclodextrin on expression levels of denitrifying functional genes in P. denitrificans.

### DETAILED DESCRIPTION OF THE EMBODIMENTS

The present disclosure will be further described below in conjunction with the drawings and specific examples of the specification. The following examples of the present disclosure are preferred embodiments of the present disclosure:

The formulas of culture media used in the examples are shown below:

Tryptone Soy Broth (TSB, g/L) includes: soya peptone: 20, NaCl: 5, dipotassium hydrogen phosphate: 2.5, and glucose: 2.5. The final pH is 7.3±0.2.

Denitrifying medium (g/L) includes: NH₄Cl: 0.58, KNO₃: 2.17, glucose: 5.0, Na₂HPO₄.12H₂O: 11.74, KH₂PO₄: 2.44, MgSO₄.7H₂O: 0.1, and trace element solution: 0.1 mL. The final pH is 7.3±0.2. The denitrifying medium is dispensed into sterile anaerobic serum bottles, and N₂ is passed into the bottles for 15 min to remove the dissolved oxygen from the solution. Each bottle is scaled with a butyl rubber stopper and an aluminum seal, and sterilized at 121° C. for 15 min.

The trace element solution (g/L) includes: Na₂.EDTA: 7.3, FeSO₄.7H₂O: 2.5, MnCl₂.4H₂O: 0.02, Na₂MoO₄.2H₂O: 0.242, CuCl₂.2H₂O: 0.135, and ZnCl₂: 0.34.

The content of nitrate nitrogen in denitrified water body is 300 mg/L.

### Example 1

Microbial culture: denitrifying microorganism P. denitrificans ATCC 19367 (American Type Culture Collection) was purchased from BeNa Culture Collection (Beijing, China) and pre-cultured with TSB sterilized in moist heat at 121° C. under aerobic conditions until OD₆₀₀ was 1.0; the bacterial suspension was washed twice with 1× phosphate buffered solution (PBS) and resuspended (OD₆₀₀ was 1.0).

Experimental group: 0.1, 0.3, 0.5, 0.8, and 1.0 mM β-cyclodextrin was added to the denitrifying medium, and the resuspended denitrifying microorganism P. denitrificans was inoculated into the denitrifying medium in the anaerobic bottle in a volume ratio of 1%; the anaerobic bottle was placed on a constant temperature shaker at 30° C. and cultured at 200 rpm.

Control group: the pre-cultured P. denitrificans was inoculated to the denitrifying medium in the anaerobic bottle in a volume ratio of 1%, without the addition of β-cyclodextrin, and the culture conditions were consistent with those of the experimental group.

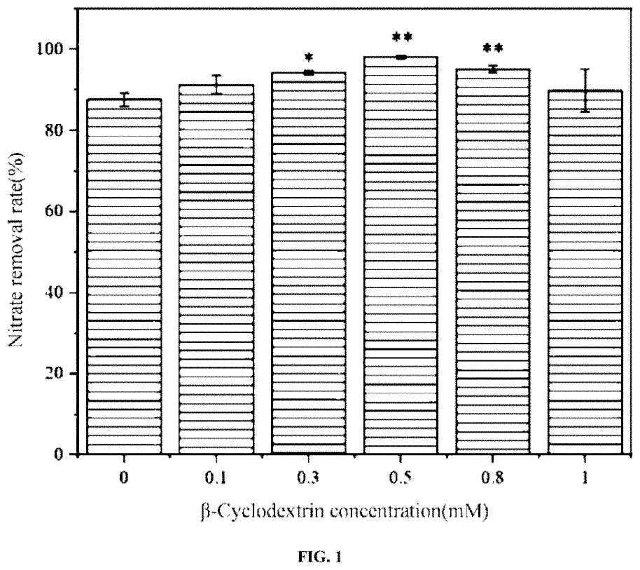

Under different β-cyclodextrin addition conditions, the nitrate removal rate in the water body at 22 h is shown in FIG. 1. The nitrate removal rate in the medium inoculated with P. denitrificans alone was 87.63%, while that in the medium supplemented with 0.5 mM β-cyclodextrin was the highest and reached 98.15%. It was proved that 0.5 mM ° dextrin had the strongest denitrification promoting effect.

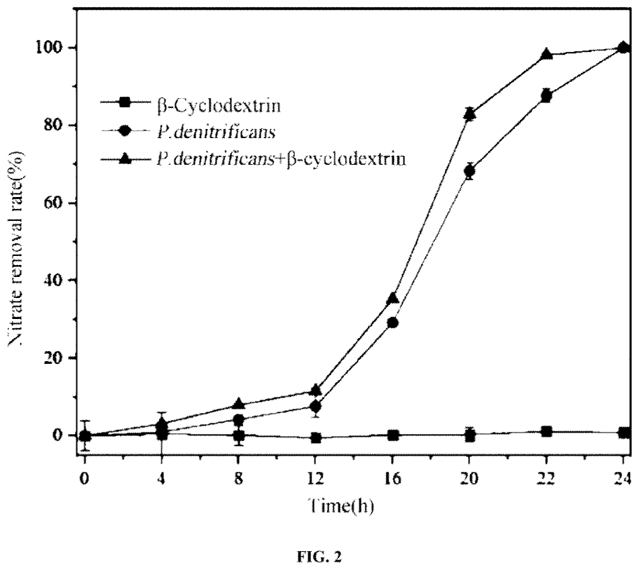

After the addition of 0.5 mM β-cyclodextrin to the denitrifying medium, the change of nitrate content in the water body within 24 h is shown in FIG. 2. Herein, at 20 h, the nitrate removal rate in the medium inoculated with P. denitrificans alone was 68.22%, while that in the medium supplemented with β-cyclodextrin was 82.82%. It was proved that 0.5 mM β-cyclodextrin could effectively enhance the denitrification ability of P. denitrificans, and β-cyclodextrin had a synergistic effect together with P. denitrificans.

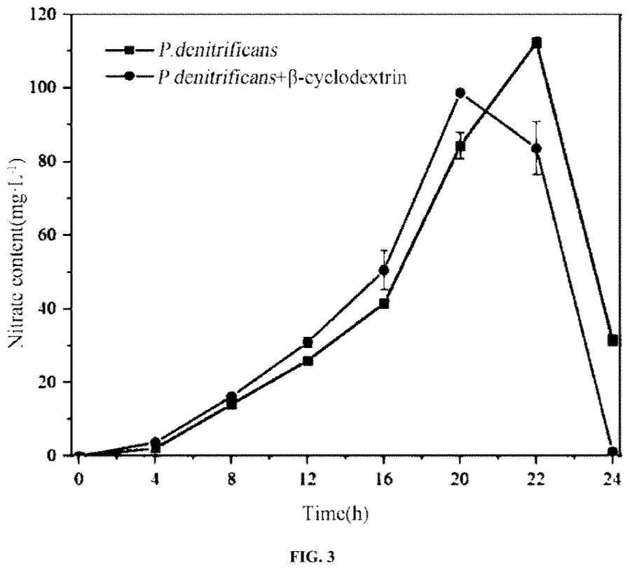

The change of nitrite content in the denitrifying medium is shown in FIG. 3. In the medium inoculated with P. denitrificans alone, the accumulation of nitrite peaked at 22 h, and its concentration was 112.33 mg·L⁻¹. The concentration of nitrite in the denitrifying medium supplemented with 0.5 mM β-cyclodextrin peaked at 20 h, and the concentration was 98.67 mg·L⁻¹. The results showed that β-cyclodextrin could promote the reduction of nitrate, so that the concentration of nitrite in the medium peaked faster. In addition, nitrate was not detected in these two treated media at 24 h; the nitrite concentration in the medium inoculated with P. denitrificans alone was 31.5 mg·L⁻¹; in the treatment group with β-cyclodextrin added, there was almost no residual nitrite at 24 h.

The results showed that β-cyclodextrin could accelerate the ability of P. denitrificans to reduce nitrite and lower the accumulation of nitrite during denitrification.

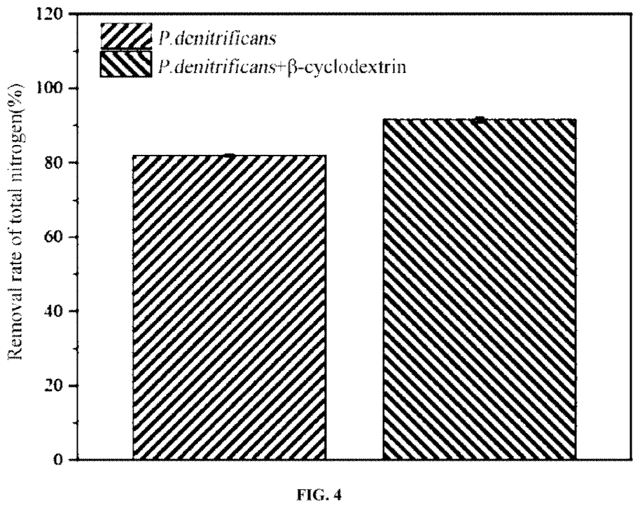

The effect of β-cyclodextrin on the removal of total nitrogen in the water body was basically consistent with its effect on enhancing nitrate removal. It can be seen from FIG. 4 that the removal rate of total nitrogen in the medium without and with 0.5 mM β-cyclodextrin by P. denitrificans is 82.01% and 91.62% at 24 h, respectively, proving that β-cyclodextrin could enhance microorganisms to remove nitrogen from the water body.

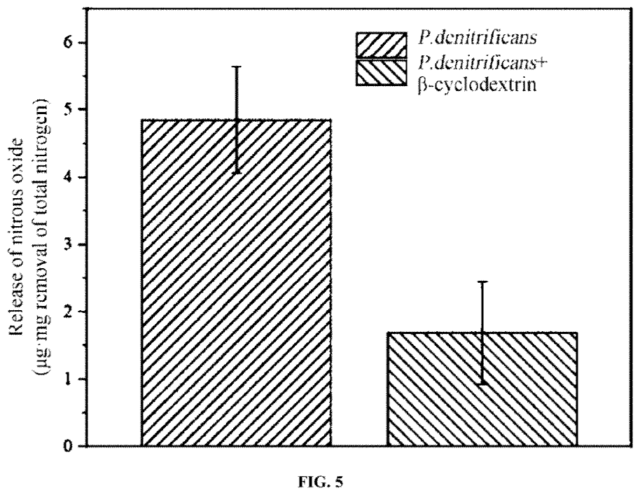

In addition, the nitrous oxide released in the denitrifying medium at 24 h was further detected. As shown in FIG. 5, 0.5 mM β-cyclodextrin significantly reduces the amount of nitrous oxide released from the medium during the removal of total nitrogen

The results showed that 0.5 mM β-cyclodextrin could make the denitrification process of P. denitrificans more thorough and reduce the total amount of nitrous oxide produced in the denitrification process.

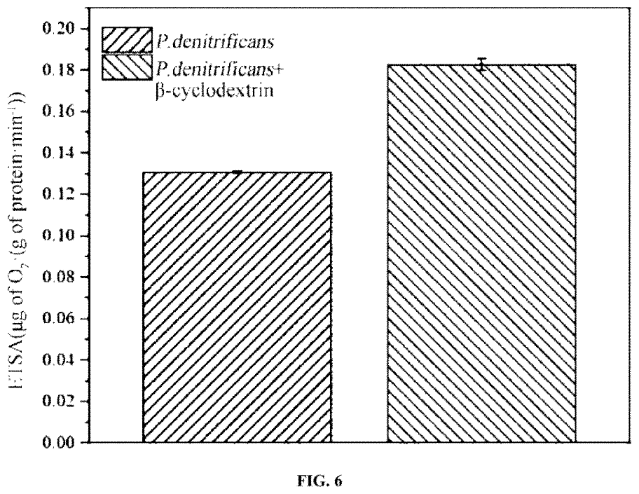

As shown in FIG. 6, it is shown that β-cyclodextrin improves ETSA in P. denitrificans. In the media without and with 0.5 mM β-cyclodextrin, the level of ETSA in P. denitrificans increased from 0.131 to 0.183 (μg of O₂.(g of protein.min⁻¹)). The increase in EISA will directly accelerate the electron transfer in the organism and enhance the biological denitrification.

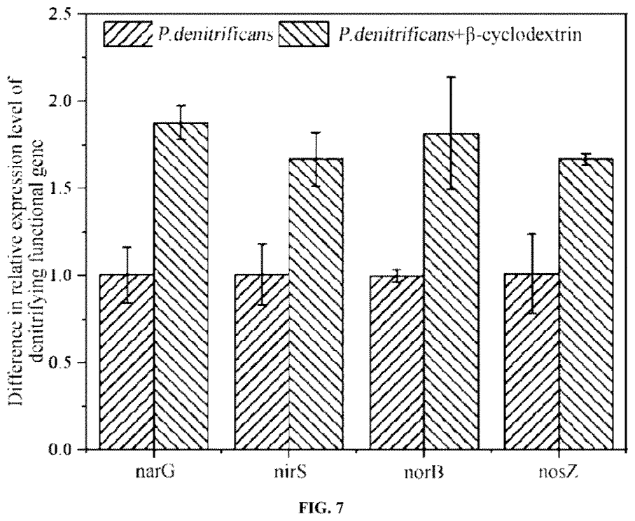

Furthermore, RT-qPGR was used to detect the effects of expression levels of denitrifying functional genes in P. denitrificans in the medium supplemented with β-cyclodextrin. As shown in FIG. 7, the denitrification-related functional genes narG, nirS, norB and nosZ are all up-regulated, and the expression levels of the four functional genes are 1.88, 1.67, 1.81 and 1.67 times that of the blank control group, respectively.

The results showed that β-cyclodextrin could achieve a more efficient and complete biological denitrification process by upregulating expression levels of denitrifying functional genes in the denitrifying model microorganism P. denitrificans.

The above examples are preferred embodiments of the present disclosure, but the embodiments of the present disclosure are not limited to the above examples, and any other changes, modifications, substitutions, combinations, and simplifications made without departing from the spirit and principle of the present disclosure should be regarded as equivalent displacements and included in the protection scope of the present disclosure.

What is claimed is:

1. A method for enhancing biological denitrification based on the addition of exogenous β-cyclodextrin, comprising a step of adding a denitrifying microorganism and β-cyclodextrin to a water body containing nitrate to realize biological denitrification treatment.

2. The method for enhancing biological denitrification based on the addition of exogenous β-cyclodextrin according to claim 1, wherein the denitrifying microorganism is selected from Paracoccus denitrificans.

3. The method for enhancing biological denitrification based on the addition of exogenous β-cyclodextrin according to claim 2, wherein the Paracoccus denitrificans is added to the water body in a volume ratio of 1%.

4. The method for enhancing biological denitrification based on the addition of exogenous β-cyclodextrin according to claim 1, wherein an amount of the β-cyclodextrin added in the water body is 0.3-0.8 mM.

5. The method for enhancing biological denitrification based on the addition of exogenous β--cyclodextrin according to claim 4, wherein the amount of the β-cyclodextrin added in the water body is 0.5 mM.

6. The method for enhancing biological denitrification based on the addition of exogenous β-cyclodextrin according to claim 1, wherein the denitrification treatment is conducted at 20-40° C.

7. The method for enhancing biological denitrification based on the addition of exogenous β-cyclodextrin according to claim 1, wherein the denitrification treatment is conducted at 30° C.

8. The method for enhancing biological denitrification based on the addition of exogenous β-cyclodextrin according to claim 7, wherein the denitrification treatment is conducted under stirring.

9. The method for enhancing biological denitrification based on the addition of exogenous cyclodextrin according to claim 7, wherein the stirring is conducted at 200 rpm.
